(19) United States
(12) Patent Application Publication
(10) Pub. No.: US 2026/0103416 A1
(43) Pub. Date: Apr. 16, 2026

(54) WATER PURIFIER

(71) Applicant: Guangdong Lizi Technology Co., Ltd., Foshan (CN)

(72) Inventors: Xing Zhan, Foshan (CN); Yining Duan, Foshan (CN); Jiawei Chen, Foshan (CN); Pingtao Chen, Foshan (CN); Wenbin Chen, Foshan (CN); Guoxiang Chen, Foshan (CN); Jianbo Huang, Foshan (CN); Yutai Huang, Foshan (CN); Xiaoping Chen, Foshan (CN)

(21) Appl. No.: 18/952,039

(22) Filed: Nov. 19, 2024

(30) Foreign Application Priority Data
Oct. 10, 2024 (CN) 202422454309.X

(51) Int. Cl. C02F 9/20; C02F 1/00; C02F 1/28; C02F 1/44

(52) U.S. Cl. CPC C02F 9/20; C02F 1/008; C02F 1/283; C02F 1/441; C02F 2201/004; C02F 2201/009

(57) ABSTRACT

A water purifier is provided, including a main housing, a waterway board component and a bracket component, the waterway board component and the bracket component are connected to form an electric-water total assembly module and are connected to the main housing. One side of the waterway board component is provided with a filter element plugging structure. A first end of the bracket component is connected to the waterway board component, the waterway board component is in “L” shaped connection with the bracket component; and the bracket component is arranged close to one side of the waterway board component. Or, the waterway board component is in “T” shaped connection with the bracket component; and the bracket component is arranged close to a middle part of one side of the waterway board component. The water purifier has a compact structure, is convenient to assemble, and has low cost.

### CROSS REFERENCE TO RELATED APPLICATIONS

The present application claims the benefit of Chinese Patent Application No. 202422454309.X filed on Oct. 10, 2024, the contents of which are incorporated herein by reference in their entirety.

### FIELD

The present disclosure relates to the technical field of water purifiers, and specifically to a water purifier.

### BACKGROUND

An existing water purifier includes many accessories, such as water pipes, filter elements, and various electrical accessories. A waterway board, a main control board, a switching power supply, a booster pump, and other components are partially assembled in a middle-frame stand, and are partially directly mounted and fixed at different positions of a housing of the water purifier. A structure of the water purifier is not compact enough, inconvenient to assembly, and costly.

### SUMMARY

In view of this, the present disclosure provides a water purifier, which is compact in structure, convenient to assemble, and conductive to reducing a cost.

The present disclosure provides a water purifier, including a main housing, a waterway board component and a bracket component, the waterway board component and the bracket component are connected to form an electric-water total assembly module and are connected to the main housing, one side of the waterway board component is provided with a filter element plugging structure; a first end of the bracket component is connected to the waterway board component, the waterway board component is in “L” shaped connection with the bracket component; and the bracket component is arranged close to one side of the waterway board component; or, the waterway board component is in “T” shaped connection with the bracket component; and the bracket component is arranged close to a middle part of one side of the waterway board component.

Optionally, wherein a mounting opening is provided in a back surface of the main housing; the electric-water total assembly module is inserted into the main housing from the mounting opening; an outer side of the waterway board component is connected to a side wall of the main housing, and the waterway board component closes the mounting opening.

Optionally, wherein the bracket component has a power supply mounting position configured to mount a power supply module, and a booster pump mounting position configured to mount a booster pump, the power supply mounting position and the booster pump mounting position are sequentially arranged in a lengthwise direction of the bracket component.

the power supply mounting position is positioned close to the waterway board component; a partition plate is provided at the power supply mounting position; the power supply module is fixed on one side of the partition plate; the booster pump is connected to the waterway board component through a connecting pipe; and the connecting pipe is arranged on the other side of the partition plate.

Optionally, at least two power supply module fixing columns are arranged on one side of the partition plate; the power supply module fixing columns are provided with screw holes; the power supply module is fixed with a lug part; the lug part has a hole for allowing a power supply module locking component to pass through; the power supply module is fixed to the power supply module fixing columns through the power supply module locking component; and a bottom of the power supply module is suspended relative to the bracket component.

Optionally, a sinking groove is provided in the booster pump mounting position; the booster pump is partially accommodated in the sinking groove, and the booster pump is fixed to the booster pump mounting position through a mounting bracket; the mounting bracket includes a supporting plate; the supporting plate is fixed on an outer side of the booster pump; the supporting plate is semi-cylindrical and is arranged in the sinking groove; two sides of the supporting plate extend outward to form flange parts; the flange parts are located on two outer side surfaces of the sinking groove; booster pump mounting holes are provided in the flange parts; the bracket component is provided with a booster pump fixing column; the booster pump fixing column is arranged below the booster pump mounting holes; the supporting plate is connected to the booster pump fixing column through a booster pump locking component; a buffer sleeve is arranged between the supporting plate and the booster pump fixing column; and the buffer sleeve sleeves the booster pump locking component.

Optionally, a strong electricity line mounting position and a weak electricity line mounting position are respectively arranged on two sides of the booster pump mounting position in a width direction; and cable tie passing holes are arranged on two sides of the bracket component.

Optionally, a second end of the bracket component is fixedly or integrally provided with a control board mounting frame, and a control circuit board is arranged in the control board mounting frame, a back surface sealing plate is arranged on one side of the control board mounting frame close to the booster pump mounting position, and an opening is provided in one side of the control board mounting frame away from the booster pump mounting position, the opening resists against an inner wall of the front panel of the main housing, thereby forming a control board accommodating chamber.

Optionally, two sides and a bottom of the bracket component are connected to the main housing, a first reinforcing rib and a second reinforcing rib are respectively arranged on the first side wall and the second side wall of the main housing, the control board mounting frame is provided with mounting frame limiting slots on two sides, the first reinforcing rib and the second reinforcing rib are respectively clamped in the mounting frame limiting slots.

Optionally, a first reinforcing rib and a second reinforcing rib are respectively arranged on the opposite first side wall and second side wall of the main housing, the first reinforcing rib and the second reinforcing rib both extend in a direction from the mounting opening towards the main housing, first limiting slots and second limiting slots are provided in two sides of the waterway board component, the first limiting slots are clamped to the first reinforcing rib, and the second limiting slots are clamped to the second reinforcing rib.

Optionally, the main housing has a third side wall and a fourth side wall which are opposite to each other, at least two housing convex ribs are arranged on the third side wall, the bottom of the bracket component is provided with at least two bracket convex ribs, and the housing convex ribs are connected to the bracket convex ribs, a fourth limiting slot is provided in a top of the waterway board component, a fourth reinforcing rib is arranged on a fourth side wall of the main housing, and the fourth reinforcing rib is clamped in the fourth limiting slot.

The present disclosure provides a water purifier. The waterway board component and the bracket component are connected to form the electric-water total assembly module and are connected to the main housing, without a need for a middle frame or other components inside the main housing. The product has a compact structure, is convenient to assemble, and has low cost.

### BRIEF DESCRIPTION OF THE DRAWINGS

In order to more clearly illustrate technical solutions in the embodiments of the present disclosure, a brief introduction will be given below to the drawings required for the embodiments. It is apparent that the drawings described below are some embodiments of the present disclosure. For ordinary technicians in the field, other drawings can be obtained based on these drawings without any creative labor.

FIG. 1 illustrates a three-dimensional assembly diagram of a water purifier provided by an embodiment of the present disclosure, viewed from a first angle;

FIG. 2 illustrates a three-dimensional assembly diagram of a water purifier provided by an embodiment of the present disclosure, viewed from a second angle;

FIG. 3 illustrates a three-dimensional assembly diagram of an electric-water total assembly module provided by an embodiment of the present disclosure, viewed from a first angle;

FIG. 4 illustrates a three-dimensional assembly diagram of an electric-water total assembly module provided by an embodiment of the present disclosure, viewed from a second angle;

FIG. 5 illustrates a three-dimensional exploded diagram of the water purifier provided by an embodiment of the present disclosure, viewed from a first angle;

FIG. 6 illustrates a three-dimensional exploded diagram of the water purifier provided by an embodiment of the present disclosure, viewed from a second angle;

FIG. 7 illustrates a three-dimensional exploded diagram of the water purifier provided by an embodiment of the present disclosure, viewed from a third angle;

FIG. 8 illustrates a three-dimensional exploded diagram of the water purifier provided by an embodiment of the present disclosure, viewed from a fourth angle;

FIG. 9 illustrates a three-dimensional exploded diagram of the water purifier provided by an embodiment of the present disclosure, viewed from a fifth angle;

FIG. 10 illustrates a three-dimensional exploded diagram of the water purifier provided by an embodiment of the present disclosure, viewed from a sixth angle;

FIG. 11 illustrates a three-dimensional exploded diagram of the water purifier provided by an embodiment of the present disclosure, viewed from a seventh angle;

FIG. 12 illustrates a three-dimensional exploded diagram of a main housing of the water purifier provided by an embodiment of the present disclosure;

FIG. 13 illustrates a cross-sectional diagram of the water purifier provided by an embodiment of the present disclosure;

FIG. 14 illustrates a schematic structural diagram I of a waterway board component provided by an embodiment of the present disclosure;

FIG. 15 illustrates a schematic structural diagram II of a waterway board component provided by an embodiment of the present disclosure;

FIG. 16 illustrates a structural diagram of a first cover plate in the waterway board component provided by an embodiment of the present disclosure;

FIG. 17 illustrates a structural diagram of a second cover plate in the waterway board component provided by an embodiment of the present disclosure;

FIG. 18 illustrates a structural diagram of a first base in the waterway board component provided by an embodiment of the present disclosure;

FIG. 19 illustrates a structural diagram of a second base in the waterway board component provided by an embodiment of the present disclosure;

FIG. 20 illustrates a structure diagram of various interface on a second mounting portion of the waterway board component provided by an embodiment of the present disclosure.

### DETAILED DESCRIPTION

Below, the technical solution in the embodiments of the present disclosure shall be described in detail and completely, combining with the accompanying drawings provided by the embodiments of the present disclosure. It will be evident that the described embodiments merely represent a part of the implementation examples of the present disclosure, and not all of them. Based on the exemplary embodiments of the present disclosure, all other embodiments obtained by persons of ordinary skill in the art without exerting creative labors, fall within the scope of protection of the present disclosure.

In the specifications, claims and accompanying drawings of the present disclosure, the terms “first,” “second,” and so on are used to distinguish different objects, and not to describe any specific sequence. Furthermore, the terms “including” and “having,” as well as their various permutations, are intended to cover non-exclusive inclusions. For instance, a process, method, system, product, or device that includes a series of steps or units is not limited to those steps or units listed but optionally may also include unlisted steps or units, or optionally include other steps or units inherent to these processes, methods, products, or devices.

Terms “embodiment” or “implementation” is mentioned in the document, implies that specific features, structures, or characteristics described in conjunction with the embodiment or implementation can be incorporated into at least one embodiment of the present invention. The appearance of this phrase at various locations within the specification does not necessarily refer to the same embodiment; nor are they mutually exclusive independent or alternative embodiments. Those skilled in the art understand explicitly and implicitly that the embodiments described herein can be combined with other embodiments.

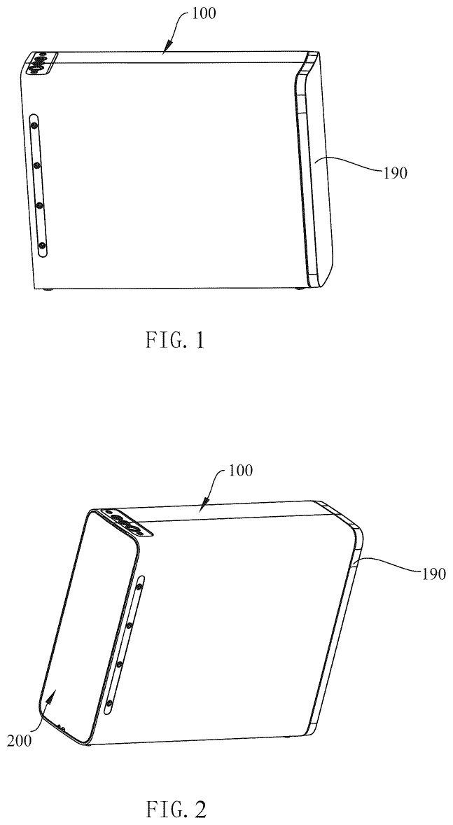

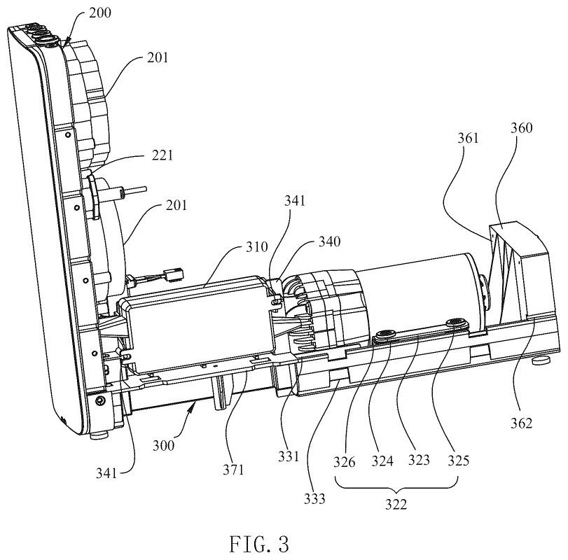

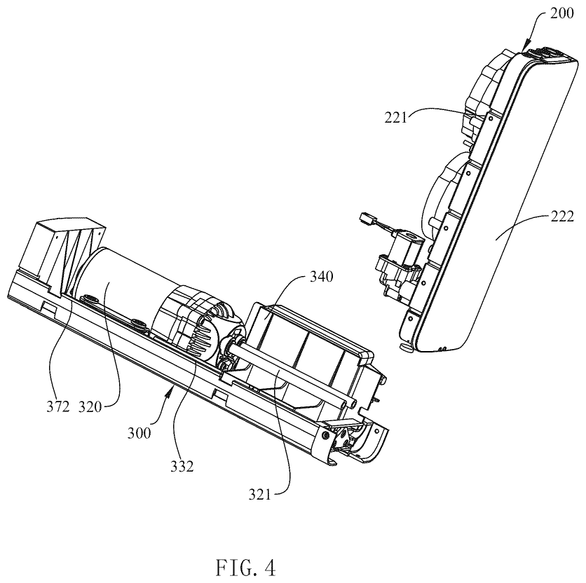

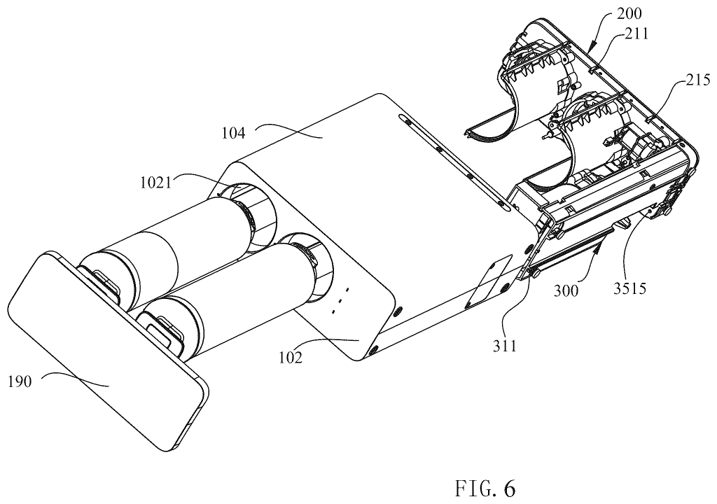

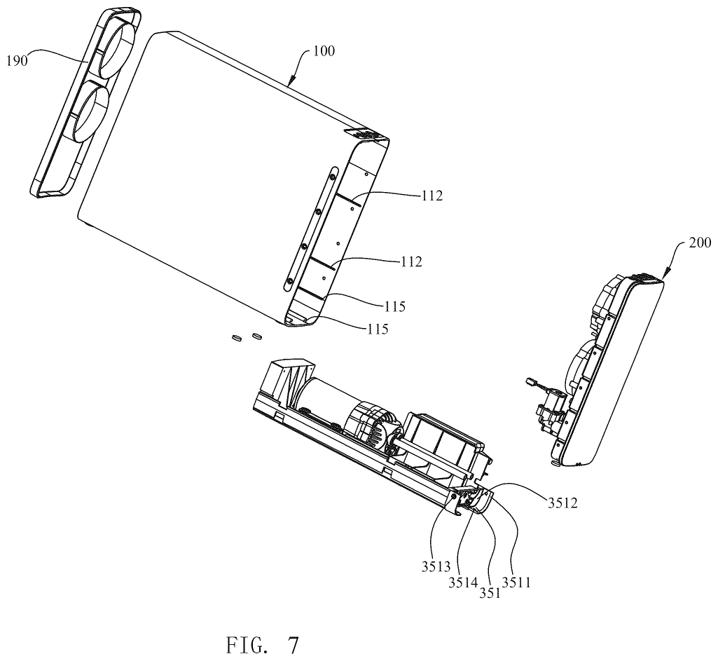

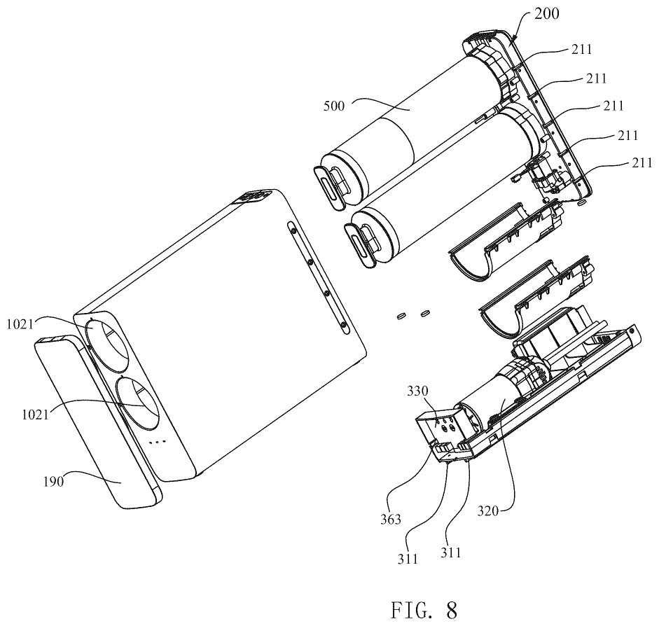

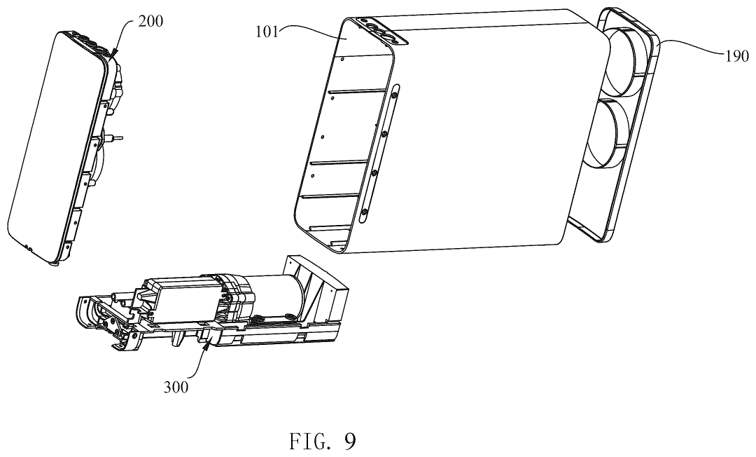

This embodiment provides a water purifier, as shown in FIG. 1 to FIG. 9, including a main housing 100, a waterway board component 200 and a bracket component 300, the waterway board component 200 and the bracket component 300 are connected to form an electric-water total assembly module and are connected to the main housing 100. One side of the waterway board component 200 is provided with a filter element plugging structure 201. The filter element plugging structure 201 is configured to allow a filter element component 500 to be plugged. The waterway board component 200 is in “L” shaped connection with the bracket component 300 to form the electric-water total assembly module; and the bracket component 300 is arranged close to one end of the waterway board component 200. The waterway board component 200 can be longitudinally designed. The bracket component 300 is transversely connected to a bottom of one side of the waterway board component 200, as shown in FIG. 3, forming an L-shaped electric-water total assembly module, which can be overall plugged into the main housing 100 and is fixed to the main housing 100. Wherein, the bracket component 300 can be close to a bottom of the main housing 100, so that the stability is good. Or, of course, the bracket component 300 can be close to an inner top of the main housing 100. Even if water leaks from the connection port of the filter element component 500, the electrical components such as the power supply module 310 and the booster pump 320 will not be affected, and the reliability is good.

Alternatively, the waterway board component 200 can be in (lateral) “T” shaped connection with the bracket component 300; and the bracket component 300 is arranged close to a middle part of one side of the waterway board component 200. The waterway board component 200 can be designed longitudinally, and the bracket component 300 is horizontally connected to a middle part of one side of the waterway board component 200, thereby forming a lateral “T” shaped integrated structure. The entire lateral “T” shaped integrated structure can be plugged into the main housing 100 as a whole and fixed to the main housing 100. A front end of the bracket component 300 can be butted with an inner side of the front panel 102 of the main housing 100, and two groups of filter element components 500 can be respectively arranged on two sides of the bracket component 300. During mounting of the water purifier, the filter element component 500 can be longitudinally arranged. The front panel 102 of the main housing 100 faces upward for easy replacement of the filter element component 500.

In a specific application, the waterway board component is in “L” shaped connection with the bracket component. After the filter element component 500 is mounted from the main housing 100 of the water purifier, a connection port at a rear end of the filter element component 500 is connected to the filter element plugging structure 201, so that the connection port of the filter element component 500 is butted with the waterway board component 200. A first end of the bracket component 300 is connected to the waterway board component 200, and the bracket component 300 is vertically arranged relative to the waterway board component 200. The bracket component 300 and the filter element plugging structure 201 are located on the same side of the waterway board component 200, which can achieve an integrated design for separating water from electricity. The waterway board component 200 integrates connecting structures related to waterways. The bracket component 300 integrates electrical components. The electrical components can include a power supply module 310, a booster pump 320, and a control circuit board 330. The waterway board component 200 and the bracket component 300 are integrated and connected into a whole and assembled in the main housing 100, without a need for a middle frame or other components in the main housing 100. The product has a compact structure, is convenient to assemble, and has low cost.

In a specific application, a mounting opening 101 can be provided in a back surface of the main housing 100 of the water purifier. The electric-water total assembly module formed by the waterway board component 200 and the bracket component 300, can be inserted into the main housing 100 as a whole from the mounting opening 101. The waterway board component 200 can serve as an outer side surface of the water purifier and cover the mounting opening 101. The filter element component 500 can be inserted into the main housing 100 from a front panel 102 on a front surface of the housing and plugged into the filter element plugging structure 201. In specific mounting, the filter element component 500 can be butted with the filter element plugging structure 201 (a filter element plugging base) through a structure such as a rotary clip, a thread, or a buckle, so that the filter element component 500 is communicated to a waterway of the waterway board component 200. In this embodiment, two filter element components 500 are provided, including a five-in-one filter element and a reverse osmosis (RO) filter element.

Specifically, the bracket component 300 has a power supply mounting position configured to mount the power supply module 310, and a booster pump mounting position configured to mount the booster pump 320. The power supply mounting position and the booster pump mounting position are arranged in sequence in a lengthwise direction of the bracket component 300. The bracket component 300 has a first end and a second end in the lengthwise direction. The first end of the bracket component 300 is fixedly connected to the waterway board component 200. The power supply mounting position is close to the first end of the bracket component 300, and the booster pump mounting position is close to the second end of the bracket component 300. By using of a space in the lengthwise direction of the filter element component 500, the power supply module 310 and the booster pump 320 are properly arranged, so that a length of the entire water purifier is only slightly greater than that of the filter element component 500.

Specifically, the power supply mounting position is close to the waterway board component 200, and a partition plate 340 is provided at the power supply mounting position. Spaces on two sides of the partition plate 340 are connected to the waterway board component 200. The power supply module 310 is fixed on one side of the partition plate 340. The booster pump 320 is connected to a connection port of the waterway board component 200 through a connecting pipe 321. The connecting pipe 321 is arranged on the other side of the partition plate 340. Even if water leaks from the connecting pipe 321, the power supply module 310 will not be directly affected by the water leakage, and the reliability is better.

Specifically, at least two power supply module fixing columns 341 are arranged on one side of the partition plate 340; the power supply module fixing columns 341 are provided with screw holes; the power supply module 310 is fixed with a lug part; the lug part has a hole for allowing a power supply module locking component to pass through; the power supply module 310 is fixed to the power supply module fixing columns 341 through the power supply module locking component (a screw); and a bottom of the power supply module 310 is suspended relative to the bracket component 300. In this way, the power supply module 310 is suspended relative to inner bottoms of both the bracket component 300 and the main housing 100. Even if water is accumulated in the main housing 100 due to water leakage, the power supply module 310 will not be directly affected, so that the safety and the reliability are better.

Specifically, a sinking groove is provided in the booster pump mounting position; the booster pump 320 is partially accommodated in the sinking groove, and the booster pump 320 is fixed to the booster pump mounting position through a mounting bracket 322, so that the structural reliability is good.

Specifically, the mounting bracket 322 includes a supporting plate 326. The supporting plate 326 is fixed to an outer side of the booster pump 320. The booster pump 320 can be fixed to the supporting plate 326 by a screw. The supporting plate 326 is semi-cylindrical and is arranged in the sinking groove; two sides of the supporting plate 326 extend outward to form flange parts 323; the flange parts 323 are located on two outer sides of the sinking groove; booster pump mounting holes are provided in the flange parts 323; the bracket component 300 is provided with a booster pump fixing column; the booster pump fixing column is arranged below the booster pump mounting holes; the supporting plate 326 is connected to the booster pump fixing column through a booster pump locking component 324 (a screw); a buffer sleeve 325 (rubber sleeve) is arranged between the supporting plate 326 and the booster pump fixing column; and the buffer sleeve 325 sleeves the booster pump locking component 324. A buffer effect of the booster pump 320 is good.

In particular, a strong electricity line mounting position 331 and a weak electricity line mounting position 332 are respectively arranged on two sides of the booster pump mounting position in a width direction; and cable tie passing holes 333 are arranged on two sides of the bracket component 300. Wires can be placed in a manner of separating strong electricity from weak electricity and are fixed by cable ties, so that a reliability is good. In specific application, the waterway board component 200 can be provided with a Total Dissolved Solids (TDS) sensor and a Negative Temperature Coefficient thermistor (NTC) temperature sensor. A control circuit board 330 is arranged at a second end of the bracket component 300, and the TDS sensor and NTC temperature sensor can be connected to the control circuit board 330 through a cable of the weak electricity line mounting position 332. A power cable of the booster pump 320 can be arranged at the strong electricity line mounting position 331.

In this embodiment, the entire back surface of the main housing 100 is set as the mounting opening 101, and four sides of the waterway board component 200 are connected to an inner side wall of the main housing 100. The main housing 100 is of an integrated structure. A filter element mounting hole 1021 is provided in a front panel 102 on a front surface of the main housing, and the back surface is designed with a full opening. The waterway board integrated component is directly connected to an inner side of the main housing 100. The product has a compact structure, is convenient to assemble, and has low production cost.

Specifically, inner-side convex ribs arranged on two opposite sides in the main housing 100. The inner-side convex ribs are placed in an insertion direction of the waterway board integrated component. The waterway board component 200 and/or the bracket component 300 is provided with mating parts connected to the inner-side convex ribs. Specifically, two opposing side walls of the main housing 100 are a first side wall 103 and a second side wall 104, respectively. A first reinforcing rib 111 and a second reinforcing rib 112 are respectively arranged on the opposite first side wall 103 and second side wall 104 of the main housing 100. The inner-side convex ribs include the first reinforcing rib 111 and the second reinforcing rib 112. The first reinforcing rib 111 and the second reinforcing rib 112 both extend in a direction from the mounting opening 101 towards the front panel 102 of the main housing 100. First limiting slots 211 and second limiting slots 212 are provided in two sides of the waterway board component 200 and two sides of the bracket component 300. The first limiting slots 211 are clamped to the first reinforcing rib 111, and the second limiting slots 212 are clamped to the second reinforcing rib 112. A stability of mounting of the various components is good, without a need for excessive screws or buckle structures, which is conducive to further improving the assembling efficiency and reducing the cost. Further, by the arrangement of the reinforcing ribs, a structural strength of the main housing 100 is effectively improved, to preventing deformation of the main housing 100 and achieve higher structural reliability.

Specifically, in this embodiment, a lower side wall (bottom wall) of the main housing 100 is defined as a third side wall 105, and an upper side wall (top wall) of the main housing 100 is defined as a fourth side wall 106. A bottom of the bracket component 300 is connected to the third side wall 105 of the main housing 100. A third reinforcing rib 213 is arranged on the third side wall 105 of the main housing 100. The third reinforcing rib 213 extends into the main housing 100 along the mounting opening 101. The bracket component 300 is provided with a plurality of convex ribs 311. The convex ribs 311 are connected to the third reinforcing rib 213 in a staggered manner. Alternatively, a limiting slot is formed between two convex ribs 311, and the third reinforcing rib 213 is clamped in the limiting slot, which achieves a good mounting and positioning effect. A gap is reserved between the bottom of the bracket component 300 and an inner bottom of the main housing 100. Even if water is accumulated in the main housing 100 due to water leakage, the electrical components on the bracket component 300 can be prevented from being directly soaked by the accumulated water. A fourth limiting slot 214 is provided in a top of the waterway board component 200. A fourth reinforcing rib 114 is arranged on the fourth side wall 106 of the main housing 100. The fourth reinforcing rib 114 extends into the main housing 100 along the mounting opening 101, and is clamped in the fourth limiting slot 214. In this way, a periphery of the waterway board integrated component is assembled and constrained by the ribs and slots matching structures in four directions, so that its internal structure is stable. The waterway board component 200 overall covers the mounting opening 101 on the back surface of the main housing 100.

In the embodiment, screw through holes 107 are provided in positions, close to the mounting opening 101, on the first side wall 103 and the second side wall 104 of the main housing 100. Countersunk screws are arranged at the screw through holes 107. The countersunk screws are in threadedly connected to the two sides of the waterway board component 200 to prevent the waterway board integrated component from exiting the mounting opening 101. A patch (not shown in the figure) is arranged at each countersunk screw. The patches can be flush with the first side wall 103 and second side wall 104 of the main housing 100. A color, a surface texture, and a pattern of each patch can be consistent with the outer side of the main housing 100 to achieve good consistency in the appearance of the product.

Specifically, a supporting slot 351 is provided in one end of the bracket component 300. The waterway board component 200 is partially inserted into the supporting slot 351 and is limited by the supporting slot 351. The bracket component 300 is provided with locking components on two sides or/and at a bottom of the supporting slot 351. The locking components are configured to lock the waterway board component 200 to the supporting slot 351 of the bracket component 300. The locking components may be screws. A lower end of the waterway board component 200 is inserted into the supporting slot 351 of the bracket component 300, and is locked and connected through the locking components to form a electric-water total assembly module (i.e. the waterway board integrated component), which has good connection reliability.

Specifically, one surface of the waterway board component 200 facing an inner cavity of the main housing 100 is a waterway connection surface 221, and the opposite surface is an appearance surface 222. A filter element plugging structure 201 is arranged on the waterway connection surface 221. The filter element plugging structure 201 is configured to allow a filter element component 500 to be plugged. A filter element mounting position is provided in the main housing 100. The filter element mounting position is arranged above the bracket component 300.

Specifically, the waterway board component 200 includes a first cover plate 10 and a second cover plate 20. The first cover plate 10 and the second cover plate 20 are fixedly connected towards each other to form a waterway chamber. One end of the first cover plate 10 is inserted into the supporting slot 351, and one surface of the second cover plate 20 opposite to the first cover plate 10 partially abuts against an end surface of the first end of the bracket component 300, making it easy for positioning during butting and improving the assembling accuracy.

Specifically, a portion of the first cover plate 10 inserted into the supporting slot 351 is a plugging part, and a portion of the first cover plate 10 located outside the supporting slot 351 is an exposed part. A side wall of the plugging part is sunken inwards relative to a side wall of the exposed part. Two opposite outer side surfaces of the exposed part and two opposite outer side surfaces of the bracket component 300 abut against an inner side wall of the main housing 100, so that the outer side of the waterway board component 200 can be flush with the outer side of the bracket component 300, avoiding formation of a step structure between the outer side of the waterway board component 200 and the outer side of the bracket component 300. When the whole is mounted in the main housing 100, the outer side of the waterway board component 200 and the outer side of the bracket component 300 can simultaneously abut against the opposite first side wall 103 and second side wall 104 of the main housing 100, so that the structural reliability is better.

Specifically, limiting clamping slots are provided in the two opposite outer side surfaces of the exposed part. The limiting clamping slots are adjacent to the plugging part, and one side wall of each limiting clamping slot is flush with an upper end surface of the bracket component 300. Limiting protrusions are arranged on the inner side of the main housing 100. The limiting protrusions are inserted into the limiting clamping slots, and the limiting protrusions abut against an upper end surface of the bracket component 300 and further limit the mounting of the waterway board component 200 and the bracket component 300.

Specifically, screw through holes 107 are provided in positions, close to the mounting opening 101, on the first side wall 103 and the second side wall 104 of the main housing 100. Countersunk screws are arranged at the screw through holes 107. The countersunk screws are in threadedly connected to the two sides of the waterway board component 200 to prevent the waterway board integrated component from exiting the mounting opening 101. A patch is arranged at each countersunk screw. The patches can be flush with the first side wall 103 and second side wall 104 of the main housing 100. A color, a surface texture, and a pattern of each patch can be consistent with the outer side of the main housing 100 to achieve good consistency in the appearance of the product.

Specifically, one surface of the supporting slot 351 is an open surface. The open surface penetrates through the first end of the bracket component 300, and the supporting slot 351 is provided with a guide slope 3511 close to an edge of the open surface, to facilitate mounting.

Specifically, the supporting slot 351 has an inner side surface 3512 facing the open surface. The waterway connection surface 221 resists against the inner side surface 3512 to form a reliable butted structure with a better structural reliability.

Specifically, the supporting slot 351 is a U-shaped slot and penetrates through the first end of the bracket component 300. The plugging part is U-shaped, which is matched with the supporting slot 351. Since the plugging part is adaptively butted with the supporting slot 351 and is locked by a screw, the structure is reliable

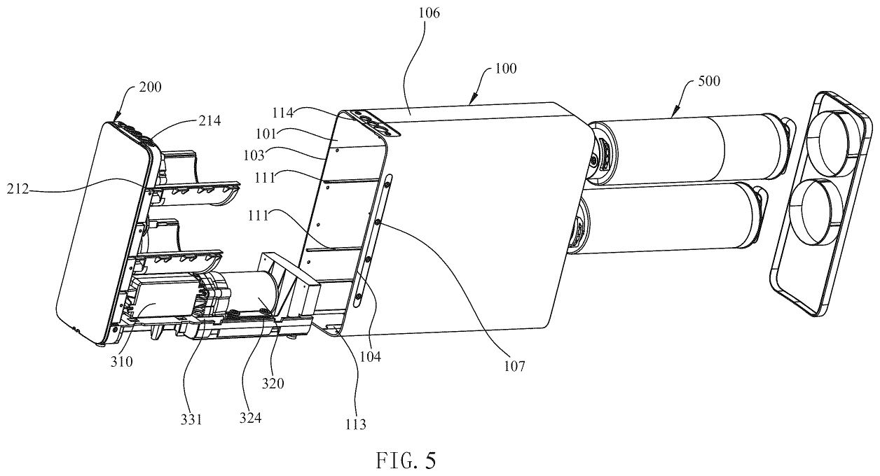

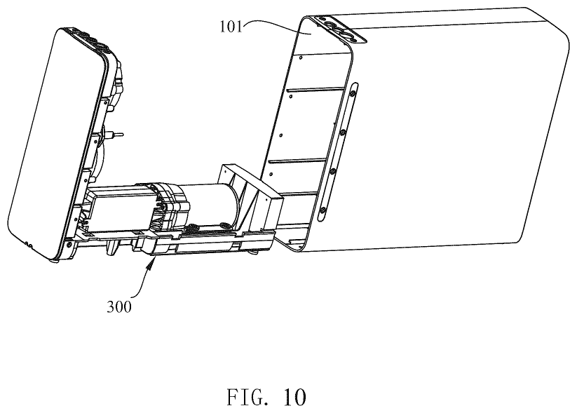

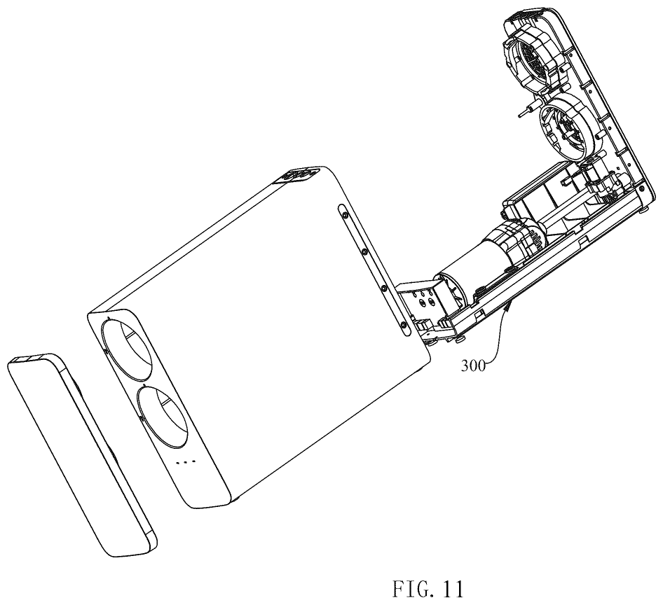

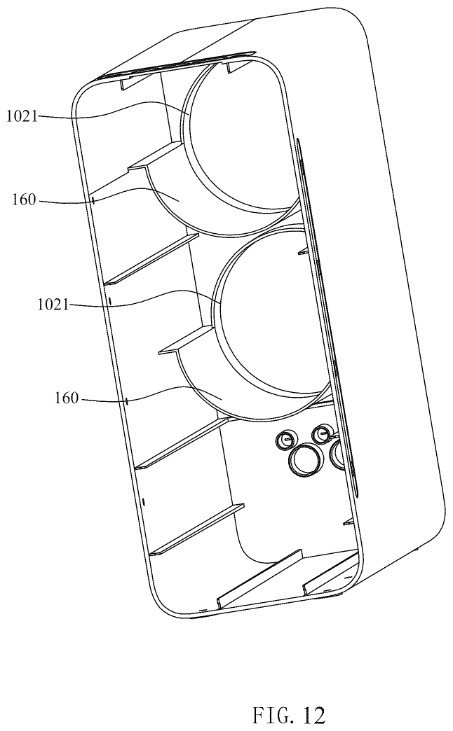

Specifically, as shown in FIG. 5 to FIG. 12, the bracket component 300 is provided with first through holes 3513 on two side surfaces of the supporting slot 351. The two opposite outer side surfaces of the first cover plate 10 are correspondingly provided with first screw holes. The locking components include first screws. The first screw passes through the first through-hole position 3513 and is to the first screw hole position The first screws pass through the first through holes 3513 and are in threadedly connected to the first screw holes. The bracket component 300 is provided with a second through hole 3514 in a bottom surface of the supporting slot 351. The second cover plate 20 is correspondingly provided with second screw holes in a bottom surface. The locking components include second screws. The second screws pass through the second through holes 3514 and are in threadedly connected to the second screw holes. The bracket component 300 is provided with third through holes 3515 on one surface of the supporting slot 351 facing the waterway connection surface 221. The waterway connection surface 221 is provided with third screw holes. The locking components include third screws. The third screws pass through the third through holes 3515 and are threadedly connected to the third screw holes. The reliability of connection between the bracket component 300 and the waterway board component 200 is good.

Specifically, a mounting opening 101 is provided in a back surface of the main housing 100. The electric-water total assembly module is plugged into the main housing 100 from the mounting opening 101 of the main housing 100. An outer side of the waterway board component 200 is connected to a side wall of the main housing 100. The waterway board component 200 closes the mounting opening 101. An appearance integrity of the product is good.

In this embodiment, a mounting opening 101 is provided in a back surface of the main housing 100. The waterway board component 200 and the bracket component 300 are connected to form the waterway board integrated component, and the waterway board integrated component is inserted into the main housing 100 as a whole from the mounting opening 101; and the waterway board component 200 closes the mounting opening 101. In this embodiment, the entire back surface of the main housing 100 is set as the mounting opening 101, and four sides of the waterway board component 200 are connected to an inner side wall of the main housing 100. The main housing 100 is of an integrated structure. A filter element mounting hole 1021 is provided in a front panel 102 on a front surface of the main housing, and the back surface is designed with a full opening. The waterway board integrated component is directly connected to an inner side of the main housing 100. The product has a compact structure, is convenient to assemble, and has low production cost.

Specifically, two opposing side walls of the main housing 100 are a first side wall 103 and a second side wall 104, respectively. A first reinforcing rib 111 and a second reinforcing rib 112 are respectively arranged on the opposite first side wall 103 and second side wall 104 of the main housing 100. The first reinforcing rib 111 and the second reinforcing rib 112 both extend in a direction from the mounting opening 101 towards the front panel 102 of the main housing 100. Limiting slots (first limiting slots 211 and second limiting slots 212) are provided in two sides of the waterway board component 200 and two sides of the bracket component 300. The first limiting slots 211 are clamped to the first reinforcing rib 111, and the second limiting slots 212 are clamped to the second reinforcing rib 112. A stability of mounting of the various components is good, without a need for excessive screws or buckle structures, which is conducive to further improving the assembling efficiency and reducing the cost. Further, by the arrangement of the reinforcing ribs, a structural strength of the main housing 100 is effectively improved, to preventing deformation of the main housing 100 and achieve higher structural reliability.

Specifically, in this embodiment, a lower side wall (bottom wall) of the main housing 100 is defined as a third side wall 105, and an upper side wall (top wall) of the main housing 100 is defined as a fourth side wall 106. The first side wall 103 and the second side wall 104 are arranged facing each other, and the third side wall 105 and the fourth side wall 106 are arranged facing each other. The first side wall 103, the second side wall 104, the third side wall 105, and the fourth side wall 106 are enclosed to form a rectangular frame. The front panel 102 of the main housing 100 is integrally connected to the first side wall 103, the second side wall 104, the third side wall 105, and the fourth side wall 106, thereby forming a housing structure with an opening in a back surface. A bottom of the bracket component 300 is connected to the third side wall 105 of the main housing 100. A third reinforcing rib 213 is arranged on the third side wall 105 of the main housing 100. The third reinforcing rib 213 extends into the main housing 100 along the mounting opening 101. The bracket component 300 is provided with a plurality of convex ribs 311. The convex ribs 311 are connected to the third reinforcing rib 213 in a staggered manner. Alternatively, a limiting slot is formed between two convex ribs 311, and the third reinforcing rib 213 is clamped in the limiting slot, which achieves a good mounting and a positioning effect. A gap is reserved between the bottom of the bracket component 300 and an inner bottom of the main housing 100. Even if water is accumulated in the main housing 100 due to water leakage, the bracket component 300 can be prevented can be prevented from being directly soaked by the accumulated water. A fourth limiting slot 214 is provided in a top of the waterway board component 200. A fourth reinforcing rib 114 is arranged on the fourth side wall 106 of the main housing 100. The fourth reinforcing rib 114 extends into the main housing 100 along the mounting opening 101, and is clamped in the fourth limiting slot 214. In this way, the waterway board integrated component is assembled and constrained by the ribs and slots matching structures in four directions, so that its internal structure is stable. The waterway board component 200 overall covers the mounting opening 101 on the back surface of the main housing 100. A waterway connection port can be provided in the fourth side wall 106 of the main housing 100. A connection port of the waterway board component 200 is flush with the waterway connection port. Screw through holes 107 are provided in positions, close to the mounting opening 101, on the first side wall 103 and the second side wall 104 of the main housing 100. Countersunk screws are arranged at the screw through holes 107. The countersunk screws are in threadedly connected to the two sides of the waterway board component 200 to prevent the waterway board integrated component from exiting the mounting opening 101. A patch is arranged at each countersunk screw. The patches can be flush with the first side wall 103 and second side wall 104 of the main housing 100. A color, a surface texture, and a pattern of each patch can be consistent with the outer side of the main housing 100 to achieve good consistency in the appearance of the product.

Specifically, one surface of the waterway board component 200 facing an inner cavity of the main housing 100 is a waterway connection surface 221. One surface of the waterway board component 200 facing away from the inner cavity of the main housing 100 is an appearance surface 222 exposed out of the mounting opening 101. The waterway connection surface 221 is provided with a filter element plugging structure 201. The filter element plugging structure 201 (i.e. a filter element plugging base) faces a filter element mounting hole 1021 of the front panel 102. One end of the first limiting slot 211 and one end of the second limiting slot 212 penetrate into the waterway connection surface 221, and the other end of the first limiting slot 211 and the other end of the second limiting slot 212 have a predetermined distance from the appearance surface 222. Namely, when the waterway board component 200 is plugged into the mounting opening 101, its mounting depth is easily found, which is conducive to improving a mounting efficiency. The first limiting slot 211 and the second limiting slot 212 are not exposed out of the appearance surface 222 of the waterway board component 200.

Specifically, the waterway board component 200 includes a first cover plate 10 and a second cover plate 20. One surface of the first cover plate 10 and one surface of the second cover plate 20 are fixedly connected towards each other to form a waterway chamber. The other surface of the first cover plate 10 is the waterway connection surface 221, and the other surface of the second cover plate 20 is the appearance surface 222. The appearance surface 222 is flush with an edge of the mounting opening 101 of the main housing. The first limiting slot 211 and the second limiting slot 212 are provided in the first cover plate 10. The first limiting slot 211 and the second limiting slot 212 penetrates to the waterway connection surface 221 from the surface of the first cover plate 10 connected to the second cover plate 20. Namely, the first reinforcing rib 111 and the second reinforcing rib 112 extend into the first limiting slot 211 and the second limiting slot 212, and end portions of both the first reinforcing rib 111 and the second reinforcing rib 112 press against the second cover plate 20. The entire second cover plate 20 closes the mounting opening 101, and the limiting slots and the reinforcing ribs are not exposed out of the appearance surface 222.

Specifically, cross sections of both the first reinforcing rib 111 and the second reinforcing rib 112 are in suitable shapes such as rectangle, dovetail, L, Y, or T. Shapes of cross sections of both the first limiting slot 211 and the second limiting slot 212 are matched with the shapes of the first reinforcing rib 111 and the second reinforcing rib 112. In this embodiment, rectangular (“ [symbol] ”-shaped) reinforcing ribs are taken as an example. This achieves a simple structure and a low cost. Of course, the reinforcing ribs may also be a dovetail-shaped, a L-shaped, and the like. When the limiting slots cooperate with the reinforcing ribs, the main housing 100 can be prevented from bulging and deforming outward.

Specifically, bayonet slots 115 are provided in one end of the first reinforcing rib 111 close to the mounting opening 101 and one end of the second reinforcing rib 112 close to the mounting opening 101. The bayonet slots 115 are arranged close to the inner side wall of the main housing 100. The waterway board component 200 is provided with convex blocks 215 at the first limiting slot 211 and the second limiting slot 212. The convex blocks 215 are inserted into the bayonet slots 115 to prevent the mounting opening 101 from deforming outward due to a force, thereby better improving a stability of mounting.

Specifically, The bracket component 300 is provided with a plurality of convex ribs 311, the third limiting slot is formed between two convex ribs 311, and/or, one end of the third reinforcing rib 213 close to the mounting opening 101 is provided with bayonet grooves 115, and the bayonet grooves 115 are arranged close to the inner side wall of the main housing 100. The waterway board component 200 is provided with convex blocks at the third limiting slot. The convex blocks are inserted into the bayonet slots 115 to prevent the mounting opening 101 from deforming outward due to a force, thereby better improving a stability of mounting.

Specifically, a fourth limiting slot 214 is provided in a top of the waterway board component 200, and a fourth reinforcing rib 114 is arranged on the fourth side wall 106 of the main housing 100. The fourth reinforcing rib 114 extends into the main housing 100 along the mounting opening 101, and is clamped in the fourth limiting slot 214, so that the structural reliability is good.

Specifically, the main housing 100 has a front panel 102, which is used as a filter element mounting side. The filter element mounting side is provided with a filter element mounting hole 1021 for the filter element component 500 to be inserted, and the filter element component 500 can be butted to the filter element plugging structure 201 of the waterway board component 200. A main lining plate 160 is integrally arranged in the filter element mounting hole 1021, and the main lining plate 160 extends from an edge of the filter element mounting hole 1021 to a direction of the filter element plugging structure 201. There is a predetermined distance between the main lining plate 160 and the filter element plugging structure 201. Due to an injection molding process, when the main lining plate 160 extends to a position close to the mounting opening 101, it is difficult for forming. Therefore, during production, the main lining plate 160 has a predetermined distance from the mounting opening 101 on the back surface of the main housing 100. This makes a molding of the main lining plate 160 relatively easier, thereby reducing a production cost of the main housing 100.

Below the filter element plugging structure 201, the waterway connection surface 221 is fixedly connected to an auxiliary lining plate 610. One end of the auxiliary lining plate 610 is fixed to the waterway connection surface 221, while the other end abuts against the edge of the main lining plate 160. Therefore, from the filter element mounting hole 1021, there is no obvious hollow portions, so that an user experience is good. Lining plate limiting slots 611 are provided in the two sides of the auxiliary lining plate 610. The lining plate limiting slots 611 sleeves the first reinforcing rib 111 and the second reinforcing rib 112, ensuring excellent installation reliability of the auxiliary lining plate 610.

Specifically, the auxiliary lining plate 610 is cylindrical or semi-cylindrical. A front end of the auxiliary lining plate 610 is provided with a fitting portion for sticking to the outer circumference of the end of the main lining plate 160. A connection between the auxiliary lining plate 610 and the main lining plate 160 can also adopt a plug-sleeve fitting structure, which is reliable.

Specifically, the second end of the bracket component 300 is fixedly or integrally provided with a control board mounting frame 360, and a control circuit board 330 is arranged in the control board mounting frame 360. The control circuit board 330 faces an inner side of the front panel 102 of the main housing 100.

Specifically, a back surface sealing plate 361 is arranged on one side of the control board mounting frame 360 close to the booster pump mounting position, and an opening is provided in one side of the control board mounting frame 360 away from the booster pump mounting position. The opening resists against an inner wall of the front panel 102 of the main housing 100, thereby forming a control board accommodating chamber. The control circuit board 330 is encapsulated in the control board accommodating chamber, which is not easily affected by water vapor inside the main housing 100 and has good reliability.

Specifically, the control board mounting frame 360 is provided with mounting frame limiting slots 362 on two sides. The first reinforcing rib 111 and the second reinforcing rib 112 are respectively clamped in the mounting frame limiting slots 362. The control circuit board 330 is provided with an indicator lamp. The front panel 102 on the front surface of the main housing 100 is provided with an indicator lamp light-transmittance region corresponding to the indicator lamp for a user to identify a working state of the product. Specifically, the back surface sealing plate 361 is provided with a wire passing hole for a cable to pass through. The control circuit board 330 abuts against the back surface sealing plate 361. The control circuit board 330 is located above the wire passing hole. The control circuit board 330 is positioned relatively upward to avoid the influence and interference of water vapor.

Specifically, a sealing rubber pad can be arranged at an edge of the opening. The control board mounting frame 360 resists against the inner side of the front panel 102 through the sealing rubber pad. Or, the edge of the opening can directly resist against the inner side of the front panel 102 to form a relatively closed control board accommodating chamber.

Specifically, two sides and a bottom of the bracket component 300 are connected to the main housing 100. A first reinforcing rib 111 and a second reinforcing rib 112 are respectively arranged on the first side wall 103 and the second side wall 104 of the main housing 100. The control board mounting frame 360 is provided with mounting frame limiting slots 362 on two sides. The first reinforcing rib 111 and the second reinforcing rib 112 are respectively clamped in the mounting frame limiting slots 362. The limiting effect on the bracket component 300 is good.

Specifically, an inner convex part 363 is arranged on an inner side wall of the control board mounting frame 360. The mounting frame limiting slots 362 are placed from the inner convex part 363 of the control board mounting frame 360. The control circuit board 330 is provided with a notch. The notch is clamped with the inner convex part 363. The control circuit board 330 is fixed to the control board mounting frame 360 through a circuit board locking component, so that it is convenient to mount the control circuit board 330.

Specifically, a filter element mounting hole 1021 is provided in a front surface of the main housing 100. The filter element mounting hole 1021 is configured to allow a filter element component 500 to extend into the main housing 100. A main lining plate 160 is integrally arranged in the main housing 100. A first end of the main lining plate 160 is integrally connected to an edge of the filter element mounting hole 1021. A hollow distance is provided between a second end of the main lining plate 160 and the waterway board component 200, and an auxiliary lining plate 610 is arranged at the hollow distance. A first end of the auxiliary lining plate 610 is connected to the waterway connection surface 221 of the waterway board component 200. The auxiliary lining plate 610 is located below the filter element plugging structure 201. A set distance is provided between the main lining plate 160 and the filter element plugging structure 201. Due to an injection molding process, when the main lining plate 160 extends to a position close to the mounting opening 101, it is difficult for forming. The main lining plate 160 has the set distance from the mounting opening 101 on the back surface of the main housing 100, to reduce the production cost of the main housing 100, The second end of the auxiliary lining plate 610 is butted with an end portion of the main lining plate 160. Due to the butting between the main lining plate 160 and the auxiliary lining plate 610, the internal structure of the main housing 100 is more stable. Therefore, from the filter element mounting position 1021, no obvious hollow portions below the filter element component 500, so that an user experience is good.

Specifically, the filter element component 500 is cylindrical, and a cross section of the main lining plate 160 is semi-cylindrical or cylindrical, to match the shape of the filter element component 500.

Specifically, a cross section of the auxiliary lining plate 610 is semi-cylindrical or cylindrical. In this embodiment, both the auxiliary lining plate 610 and the main lining plate 160 are semi-cylindrical. This achieves a simple structure and low cost.

Specifically, the first end of the auxiliary lining plate 610 is fixedly connected to the waterway board component 200 through a lining plate locking component, and an end clamping slot is provided in the second end of the auxiliary lining plate 610. The end clamping slot sleeves an edge of an end portion of the second end of the main lining plate 160. Alternatively, an end clamping slot is provided in the second end of the main lining plate 160. The second end of the auxiliary lining plate 610 is plugged into the end clamping slot. By opposite plugging, the auxiliary lining plate 610 and the main lining plate 160 form a complementary butted structure, thus achieving better structural reliability.

Specifically, the main housing 100 is further provided with a bracket component 300. The bracket component 300 has a first end and a second end in a lengthwise direction. The first end of the bracket component 300 is connected to the waterway board component 200, and the second end of the bracket component 300 abuts against an inner side wall of a front panel 102 of the main housing 100. The bracket component 300 has a power supply mounting position configured to mount a power supply module 310 and a booster pump mounting position configured to mount a booster pump 320. The power supply mounting position and the booster pump mounting position are provided in sequence in the lengthwise direction of the bracket component 300. The first end of the bracket component 300 is fixedly connected to the waterway board component 200. The power supply mounting position is close to the first end of the bracket component 300, and the booster pump mounting position is close to the second end of the bracket component 300. By use of a space in the lengthwise direction of the filter element component 500, the power supply module 310 and the booster pump 320 are properly arranged, so that the length of the entire water purifier is only slightly greater than that of the filter element component 500.

Specifically, Lining plate limiting slots 611 are provided in the two sides of the auxiliary lining plate 610. The lining plate limiting slots 611 are aligned with one of the first limiting slots 211 and one of the second limiting slots 212 and are clamped to the first reinforcing ribs 111 and the second reinforcing ribs 112, so that the two sides of the auxiliary lining plate 610 are supported and limited by the first reinforcing ribs 111 and the second reinforcing ribs 112.

Specifically, the two sides of the main lining plate 160 are integrally connected to the first side wall 103 and the second side wall 104 of the main housing 100 through connecting ribs. An integral connection structure is provided between the first side wall 103 and the second side wall 104. This achieves better structural stability.

Specifically, guide slopes are arranged at openings of ends of the lining plate limiting slots 611 away from the waterway board component 200, so that it is convenient to align and plug the lining plate limiting slot 611 to the first reinforcing ribs 111 and the second reinforcing ribs 112, which is convenient for assembling.

Specifically, at least two filter element mounting holes 1021 are provided in the front surface of the main housing 100, and the waterway board component 200 is correspondingly provided with at least two filter element plugging structures 201. A surface cover plate 190 is arranged on the front surface of the main housing 100. The surface cover plate 190 can cover the front panel 102 to block the filter element mounting holes 1021. This achieves better appearance consistency.

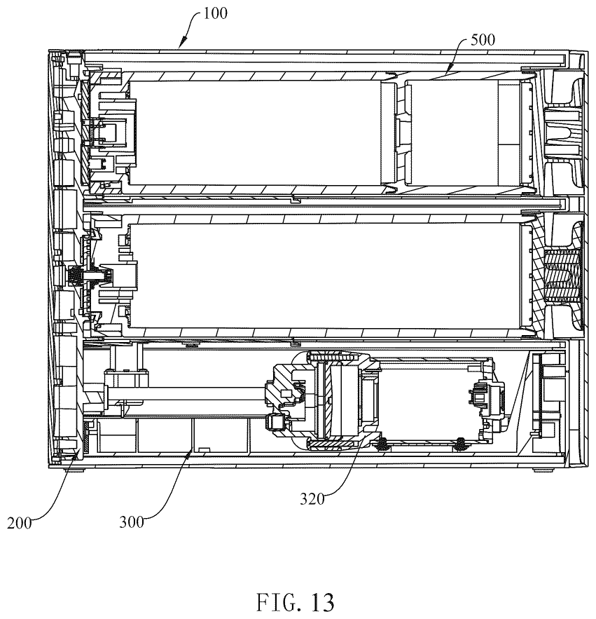

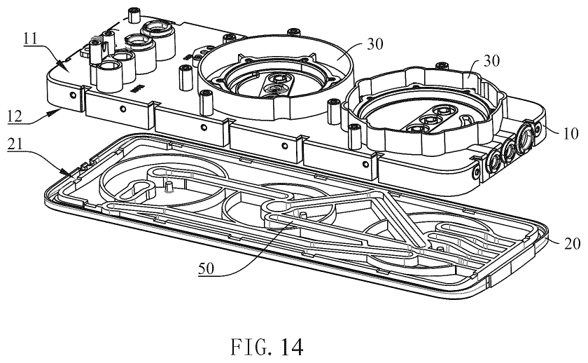

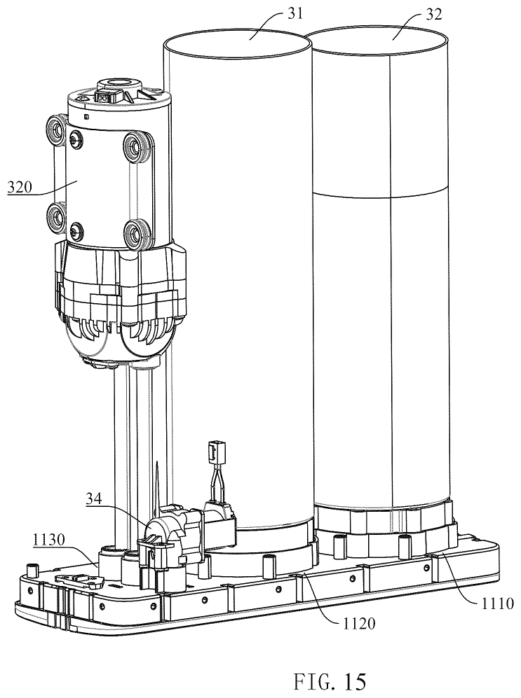

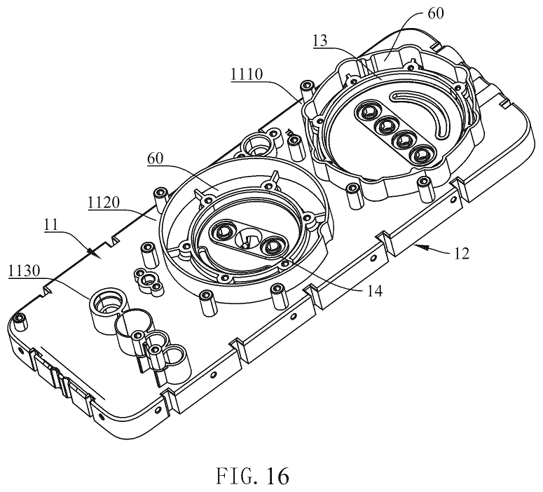

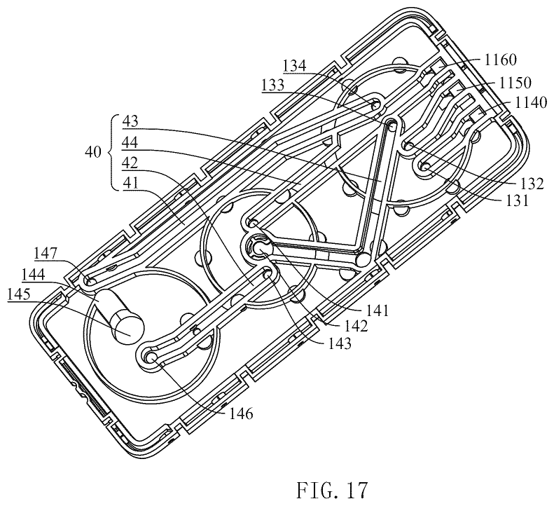

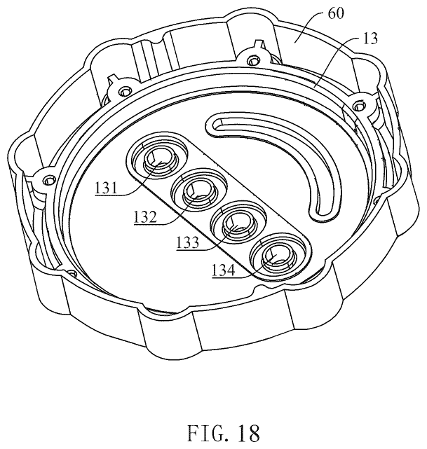

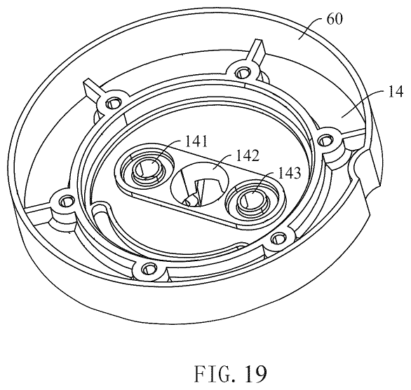

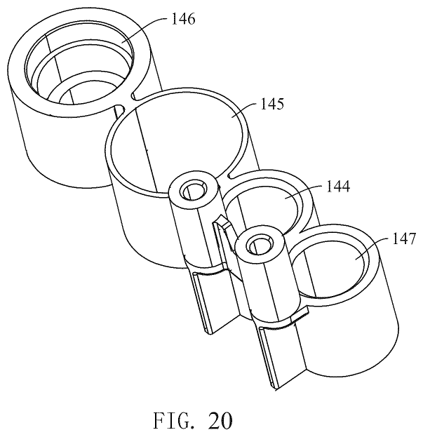

As shown in FIG. 13 to FIG. 20, the above waterway board component 200 includes a first cover plate 10 and a second cover plate 20. The first cover plate 10 and the second cover plate 20 are connected to each other by bonding or laser welding. The first cover plate 10 has a first surface 11 and a second surface 12. Filter element components 500 are arranged on the first surface 11, and flow guide slot structures 40 are arranged on the second surface 12. A plurality of flow guide members 50 are correspondingly arranged on a third surface 21 of the second cover plate 20 facing the second surface 12. By the cooperation between the flow guide members 50 and the flow guide slot structures 40, flow guide channels can be formed. The filter element components 500 arranged on the first surface 11 are communicated through the flow guide channels, so that water can flow in the filter element components 500. The filter element components 500 are directly mounted on the first cover plate 10 and a waterway board component is connected by bonding the first cover plate 10 with the second cover plate 20. This can achieve the purpose of reducing the volume of the water purifier.

In some embodiments, the plurality of filter element components 500 include an RO filter element 31 and a composite filter element 32. The first surface 11 is further provided with a first mounting portion 1110, a second mounting portion 1120, and a third mounting portion 1130. The composite filter element 32 is arranged at the first mounting portion 1110. The RO filter element 31 is arranged at the second mounting portion 1120. A booster pump and a water inlet valve 34 are arranged at the third mounting portion 1130.

In some embodiments, the first mounting portion 1110 is provided with a first base 13. The composite filter element 32 is arranged on the first base 13.

The first base 13 includes: a first filter element connection port 131, a second filter element connection port 132, a third filter element connection port 133, and a fourth filter element connection port 134.

The first filter element connection port 131, the second filter element connection port 132, the third filter element connection port 133, and the fourth filter element connection port 134 are all communicated to the composite filter element 32.

It can be understood that the first base 13 is arranged on the first mounting portion 1110, so that the first base 13 can play a role of positioning the filter element components 500 mounted on the waterway board component 200, or it can be convenient to directly mount the filter element components 500 on the first base 13, so that the filter element components 500 are in direct contact with the first base 13. In this way, it can be convenient to mount or remove the filter element components 500 in or from the water purifier.

It can be understood that the first base 13 is further provided with the first filter element connection port 131, the second filter element connection port 132, the third filter element connection port 133, and the fourth filter element connection port 134. The composite filter element 32 includes a first water inlet of composite filter element, a drainage outlet of composite filter element, a second water inlet of composite filter element, and a water outlet of composite filter element.

After the composite filter element 32 is mounted on the first base 13, the first water inlet of composite filter element is mounted at the first filter element connection port 131; the drainage outlet of composite filter element is mounted at the fourth filter element connection port 134; the second water inlet of composite filter element is mounted at the second filter element connection port 132; and the water outlet of composite filter element is mounted at the third filter element connection port 133. This achieves the cooperation between the filter element and the first base 13, and communicates the first base 13 to the composite filter element 32.

It can be understood that a polypropylene (PP) membrane and an activated carbon layer are arranged in the composite filter element 32. The PP membrane is configured to filter out large particles in water, and the activated carbon is to remove odor. After passing through the PP membrane, the water will enter the RO filter element 31 for filtration before entering the activated carbon layer for odor removal.

In some implementations, the second mounting portion 1120 is provided with a second base 14, and the RO filter element 31 is arranged on the second base 14.

The second base 14 includes: a fifth filter element connection port 141, a sixth filter element connection port 142, and a seventh filter element connection port 143.

The fifth filter element connection port 141, the sixth filter element connection port 142, and the seventh filter element connection port 143 are all communicated to the RO filter element 31.

It can be understood that the second base 14 is arranged on the second mounting portion 1120. The second base 14 can play a role of positioning the filter element components 500 mounted on the first cover plate 10, and it can be convenient to directly mount the filter element component 500 on the second base 14, so that the filter element components 500 are in direct contact with the second base 14. In this way, it can be convenient to mount or remove the filter element components 500 in or from the water purifier. The fifth filter element connection port 141, the sixth filter element connection port 142, and the seventh filter element connection port 143 are all configured to be communicated with the RO filter element 31. The RO filter 31 is provided with a water inlet of RO filter element, a water outlet of RO filter element, and a wastewater outlet of RO filter element. After the RO filter 31 is mounted on the second base 14, the water inlet of RO filter element is communicated to the seventh filter element connection port 143; the water outlet of RO filter element is communicated to the sixth filter element connection port 142; and the wastewater outlet of RO filter element is communicated to the seventh filter element connection port 143.

In some implementations, the third mounting portion 1130 is provided with a first booster pump connection port 144, a second booster pump connection port 145, a third booster pump connection port 146, and a connection port 147.

The connection port 147 and the first booster pump connection port 144 are both communicated to the water inlet valve 34, and the second booster pump connection port 145 and the third booster pump connection port 146 are both communicated to the booster pump 320.

It can be understood that the third mounting portion 1130 is provided with the first booster pump connection port 144, the second booster pump connection port 145, the third booster pump connection port 146, and the connection port 147. The first booster pump connection port 144, the second booster pump connection port 145, the third booster pump connection port 146, and the connection port 147 are all directly provided in the first surface 11.

The connection port 147 and the first booster pump connection port 144 are communicated to the water inlet valve 34. The connection port 147 is configured to supply water to the water inlet valve 34. The first booster pump connection port 144 is configured to discharge water from the water inlet valve 34.

The second booster pump connection port 145 and the third booster pump connection port 146 are communicated to the booster pump. The second booster pump connection port 145 is configured to supply water to the booster pump. The third booster pump connection port 146 is configured to discharge water from the booster pump.

When water enters the water inlet valve 34 through the connection port 147 and flows to the first booster pump connection port 144, the waters into the booster pump through the first booster pump connection port 144 and the second booster pump connection port 145. The booster pump 320 boosts the water and discharges the water through the third booster pump connection port 146, to achieve the boosting of the water.

In some implementations, the flow guide slot structures 40 include: a first flow guide slot 41, a second flow guide slot 42, a third flow guide slot 43, and a fourth flow guide slot 44.

The first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142.

It can be understood that the first flow guide slot 41, the second flow guide slot 42, the third flow guide slot 43, and the fourth flow guide slot 44 are all structures that protrude out of the second surface 12, which can reduce a space occupied by the plurality of flow guide slot structures 40 on the first cover plate 10. Specifically, the flow guide slot structures 40 protrude out of the second surface 12, so that a thickness of the first cover plate 10 can be set to be smaller. This can reduce the space occupied by the waterway board component 200 in the water purifier and achieve the purpose of reducing the volume of the water purifier.

It can be understood that the first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142. In this way, the RO filter element 31, the composite filter element 32, the water inlet valve 34, and the booster pump 320 can be intercommunicated to allow the water to flow in the waterway board component 200.

In some implementations, the first cover plate 10 has a water inlet 1140, a purified water outlet 1150, and a wastewater outlet 1160.

The water inlet 1140 is communicated to the fourth filter element connection port 134. The purified water outlet 1150 is communicated to the third filter element connection port 133. The wastewater outlet 1160 is communicated to the fifth filter element connection port 141 through the fourth flow guide slot 44.

It can be understood that the cover plate has the water inlet 1140, the purified water outlet 1150, and the wastewater outlet 1160. The water inlet 1140, the purified water outlet 1150, and the wastewater outlet 1160 are arranged at a portion, close to the first base 13, of the cover plate. This facilitates feeding of water into the composite filter element 32 and discharging of water after secondary purification. In this way, a length of the first cover plate 10 in a waterway can be reduced.

It can be understood that the water inlet 1140 is configured to supply municipal water to the water purifier. The purified water outlet 1150 is configured to discharge purified water. The wastewater outlet 1160 is configured to discharge wastewater generated in the RO filter element 31. Specifically, the water inlet 1140 is communicated to the first filter element connection port 131. In this way, when water enters the first cover plate 10, the water can directly flow into the composite filter element 32. The purified water outlet 1150 is communicated to the second filter element connection port 132. The water discharged from the purified water outlet 1150 is purified water filtered by activated carbon. The wastewater outlet 1160 is communicated to the fourth flow guide slot 44 and the fifth filter element connection port 141. In this way, the wastewater generated by the RO filter 31 is discharged through the fourth flow guide slot 44 to the wastewater outlet 1160, to discharge the wastewater from the RO filter 31.

A water flowing direction in the above cover plate is as follows: The water enters the waterway board component 200 through the water inlet 1140, then enters the composite filter element 32, and is filtered by the PP membrane. After filtration by the PP membrane, the water is discharged through the fourth filter element connection port 134, then flows into the connection port 147 through the first flow guide slot 41, and enters the water inlet valve 34. After flowing out of the water inlet valve 34, the water flows to the first booster pump connection port 144 and then to the second booster pump connection port 145, and enters the booster pump 320 for boosting through the second booster pump connection port 145. The water is then discharged through the third booster pump connection port 146, thus completing the boosting of the water. The boosted water flows through the second flow guide slot 42 to the seventh filter element connection port 143, and enters the RO filter element 31 through the seventh filter element connection port 143. After the RO filter element 31 filters the water, purified water is discharged from the sixth filter element connection port 142, and wastewater is discharged from the fifth filter element connection port 141. The purified water in the sixth filter element connection port 142 flows through the third flow guide slot 43 to the third filter element connection port 133 and enters an activated carbon filtering layer in the composite filter element 32 for filtration. After flowing out of the activated carbon filtering layer, the purified water is discharged out of the water purifier through the purified water outlet 1150 for drinking. The wastewater generated by the fifth filter element connection port 141 is discharged through the fourth flow guide slot 44 to the wastewater outlet 1160, and is then discharged out of the water purifier.

In some implementations, the first flow guide slot 41, the second flow guide slot 42, the third flow guide slot 43, and the fourth flow guide slot 44 all protrude out of the second surface 12.

It can be understood that the first flow guide slot 41, the second flow guide slot 42, the third flow guide slot 43, and the fourth flow guide slot 44 all protrude out of the second surface 12. This is to facilitate a cooperation with the flow guide members 50. The flow guide members 50 can be clamped into the flow guide slots. When the flow guide members 50 are clamped into the above various flow guide slots, the first cover plate 10 and the second cover plate 20 can cooperate with each other to improve a tightness of the cooperation between the flow guide members 50 and the flow guide slots.

In some implementations, both the first base 13 and the second base 14 have limiting parts 60. The limiting parts 60 all protrude out of the first surface 11.

It can be understood that both the first base 13 and the second base 14 have the limiting parts 60, and the limiting parts 60 protrude out of the first surface 11. In this way, it is convenient to mount the RO filter element 31 and the composite filter element 32 onto the first base 13 and the second base 14. Specifically, both the first base 13 and the second base 14 protrude out of the second surface 12, so that during the mounting of the composite filter element 32 and the RO filter element 31, the first base 13 and the second base 14 can play a positioning role to facilitate the mounting of the RO filter element 31 and the composite filter element 32.

Reference to “embodiment” or “implementation” in the present disclosure means that a particular feature, structure or characteristic described in conjunction with an embodiment may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described in the present disclosure may be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A water purifier, comprising: a main housing, a waterway board component and a bracket component, the waterway board component and the bracket component are connected to form an electric-water total assembly module and are connected to the main housing, one side of the waterway board component is provided with a filter element plugging structure;
a first end of the bracket component is connected to the waterway board component, the waterway board component is in “L” shaped connection with the bracket component; and the bracket component is arranged close to one side of the waterway board component; or, the waterway board component is in “T” shaped connection with the bracket component; and the bracket component is arranged close to a middle part of one side of the waterway board component.

2. The water purifier according to claim 1, wherein a mounting opening is provided in a back surface of the main housing; the electric-water total assembly module is inserted into the main housing from the mounting opening; an outer side of the waterway board component is connected to a side wall of the main housing, and the waterway board component closes the mounting opening.

3. The water purifier according to claim 1, wherein the bracket component has a power supply mounting position configured to mount a power supply module, and a booster pump mounting position configured to mount a booster pump, the power supply mounting position and the booster pump mounting position are sequentially arranged in a lengthwise direction of the bracket component;
the power supply mounting position is positioned close to the waterway board component; a partition plate is provided at the power supply mounting position; the power supply module is fixed on one side of the partition plate; the booster pump is connected to the waterway board component through a connecting pipe; and the connecting pipe is arranged on the other side of the partition plate.

4. The water purifier according to claim 3, wherein at least two power supply module fixing columns are arranged on one side of the partition plate; the power supply module fixing columns are provided with screw holes; the power supply module is fixed with a lug part; the lug part has a hole for allowing a power supply module locking component to pass through; the power supply module is fixed to the power supply module fixing columns through the power supply module locking component; and a bottom of the power supply module is suspended relative to the bracket component.

5. The water purifier according to claim 3, wherein a sinking groove is provided in the booster pump mounting position; the booster pump is partially accommodated in the sinking groove, and the booster pump is fixed to the booster pump mounting position through a mounting bracket; the mounting bracket comprises a supporting plate; the supporting plate is fixed on an outer side of the booster pump; the supporting plate is semi-cylindrical and is arranged in the sinking groove; two sides of the supporting plate extend outward to form flange parts; the flange parts are located on two outer side surfaces of the sinking groove; booster pump mounting holes are provided in the flange parts; the bracket component is provided with a booster pump fixing column; the booster pump fixing column is arranged below the booster pump mounting holes; the supporting plate is connected to the booster pump fixing column through a booster pump locking component; a buffer sleeve is arranged between the supporting plate and the booster pump fixing column; and the buffer sleeve sleeves the booster pump locking component.

6. The water purifier according to claim 3, wherein a strong electricity line mounting position and a weak electricity line mounting position are respectively arranged on two sides of the booster pump mounting position in a width direction; and cable tie passing holes are arranged on two sides of the bracket component.

7. The water purifier according to claim 1, wherein a second end of the bracket component is fixedly or integrally provided with a control board mounting frame, and a control circuit board is arranged in the control board mounting frame, a back surface sealing plate is arranged on one side of the control board mounting frame close to the booster pump mounting position, and an opening is provided in one side of the control board mounting frame away from the booster pump mounting position, the opening resists against an inner wall of the front panel of the main housing, thereby forming a control board accommodating chamber.

8. The water purifier according to claim 7, wherein two sides and a bottom of the bracket component are connected to the main housing, a first reinforcing rib and a second reinforcing rib are respectively arranged on the first side wall and the second side wall of the main housing, the control board mounting frame is provided with mounting frame limiting slots on two sides, the first reinforcing rib and the second reinforcing rib are respectively clamped in the mounting frame limiting slots.

9. The water purifier according to claim 2, wherein a first reinforcing rib and a second reinforcing rib are respectively arranged on the opposite first side wall and second side wall of the main housing, the first reinforcing rib and the second reinforcing rib both extend in a direction from the mounting opening towards the main housing, first limiting slots and second limiting slots are provided in two sides of the waterway board component, the first limiting slots are clamped to the first reinforcing rib, and the second limiting slots are clamped to the second reinforcing rib.

10. The water purifier according to claim 9, wherein the main housing has a third side wall and a fourth side wall which are opposite to each other, at least two housing convex ribs are arranged on the third side wall, the bottom of the bracket component is provided with at least two bracket convex ribs, and the housing convex ribs are connected to the bracket convex ribs, a fourth limiting slot is provided in a top of the waterway board component, a fourth reinforcing rib is arranged on a fourth side wall of the main housing, and the fourth reinforcing rib is clamped in the fourth limiting slot.
